(19) United States
(12) Patent Application Publication
(10) Pub. No.: US 2006/0236834 A1
(43) Pub. Date: Oct. 26, 2006

(54) Combination radial and miter saw

(76) Inventor: Nicholas Ange, Webster, NY (US)

Correspondence Address: JAMES RAY & ASSOCIATES, 2640 PITCAIRN ROAD, MONROEVILLE, PA, 15146, US

(21) Appl. No.: 11/408,426

(22) Filed: Apr. 21, 2006

Related U.S. Application Data
(60) Provisional application No. 60/673,438, filed on Apr. 21, 2005.

(51) Int. Cl. B27B 5/18; B27B 27/06

(52) U.S. Cl. 83/471.3; 83/471.2; 83/485

(57) ABSTRACT

A power operated saw includes a base having a horizontally disposed work surface and a support member connected to the base and extending upwardly therefrom. A saw blade assembly has a motor and a circular blade rotateably driven by the motor. The saw blade is rotatable, in a horizontal plane, and is selectively positionable within a cutting range, which is characterized by a first cutting direction and at least a second cutting direction substantially perpendicular to the first cutting direction. The blade positioned in the first cutting direction has a surface thereof oriented towards the support member and the blade positioned in the second cutting direction has an edge portion thereof oriented towards the support member.

### CROSS-REFERENCE TO RELATED APPLICATIONS

This application is related to and claims priority from Provisional Patent Application Ser. No. 60/673,438 filed Apr. 21, 2005.

### FIELD OF THE INVENTION

The present invention relates, in general, to power operated saws employing a circular saw blade and, more particularly, this invention relates to power operated saws capable of forming cross cuts, rip cuts, bevel cuts and miter cuts in a workpiece.

### BACKGROUND OF THE INVENTION

Power operated saws, particularly for woodworking operations, are well known in the art. One type of such saws, known as sliding and non-sliding miter saws, is extensively utilized for forming cross-cuts, bevel cuts and miter cuts in a typically elongated workpiece of a board type. Both saw types are portable and easily transportable between various worksites or to different locations within a single worksite.

Non-sliding miter saws include a turntable for receiving and supporting the workpiece, a fence abutting one edge of the workpiece, a support structure rigidly attached to the turntable and a circular saw blade assembly disposed above the turntable and pivotally connected to the support structure. The saw blade assembly is pivotable in a downward direction for cutting such workpiece.

Sliding type miter saws include an additional pair of rails for slideably and reciprocally connecting the saw blade assembly to the support structure and provide for an extended cutting range over conventional non-sliding miter saws. The main disadvantage of presently available sliding and non-sliding miter saws is their inability to form rip-cuts in a workpiece of a sheet type.

Another type of power operated saws, known as table saws, is utilized for forming cross-cuts, rip cuts, bevel cuts and miter cuts in a sheet type workpiece. These saws generally include a table and stand combination with a horizontally disposed work surface for supporting such large size sheets. The saw blade assembly is mounted within the table and has only a portion of the saw blade protruding above the work surface.

While such table saws are effective in processing large size sheets, they are often difficult to transport and set-up at construction sites. Furthermore, extra safety precautions which must be implemented during cutting operations increase the complexity of operating such table saws.

### SUMMARY OF THE INVENTION

According to one embodiment of the invention, there is provided a power operated saw. The saw includes a base having a horizontally disposed work surface. The work surface is engageable with and supports a workpiece. There is a support member, which is connected to the base and extends upwardly therefrom. A saw blade assembly has a motor and a circular blade rotatably driven by the motor. There is a means engageable with the support member and the blade assembly for rotating the blade assembly in a horizontal plane and for selectively positioning the blade within a cutting range. The cutting range is characterized by a first cutting direction and at least a second cutting direction. The second cutting direction is substantially perpendicular to the first cutting direction. The blade positioned in the first cutting direction has a surface thereof oriented towards the support member. The blade positioned in the second cutting direction has an edge portion thereof oriented towards the support member.

According to another embodiment, the invention provides a power operated saw which includes a base having a horizontally disposed work surface. The work surface is engageable with and supports a workpiece. An indexing table is rotatably attached to the base and forms a portion of the work surface. There is a support member, which is connected to the base and extends upwardly therefrom. A saw blade assembly has a motor and a circular blade rotatably driven by the motor. There is a means engageable with the support member and the blade assembly for rotating the blade assembly in a horizontal plane and for selectively positioning the blade within a cutting range. The cutting range is characterized by a first cutting direction and at least a second cutting direction, wherein the second cutting direction is substantially perpendicular to the first cutting direction. The blade positioned in the first cutting direction has a surface thereof oriented towards the support member and the blade positioned in the second cutting direction has an edge portion thereof oriented towards the support member.

### OBJECTS OF THE INVENTION

It is, therefore, one of the primary objects of the present invention to provide a power operated saw which is capable of forming cross cuts, rip cuts, bevel cuts and miter cuts in a workpiece.

Yet another object of the present invention is to provide a power operated saw which is portable.

A further object of the present invention is to provide a power operated saw which is simple to operate.

Yet a further object of the present invention is to provide a power operated saw which is capable of processing a sheet type workpiece.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a plan view of a power operated saw of the present invention showing a saw blade disposed in a first cutting direction;

FIG. 2 is a plan view of the power operated saw of the present invention showing the saw blade disposed in a second cutting direction;

FIG. 3 is a side elevation view of the power operated saw of the present invention showing a saw blade positioning mechanism according to one embodiment of the invention;

FIG. 4 is a side elevation view of the power operated saw of the present invention showing a saw blade positioning mechanism according to another embodiment of the invention; and

FIG. 5 is a side elevation view of the power operated saw of the present invention showing a fence positioning mechanism according to an alternative embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

Now in reference to FIGS. 1-5, there is provided a power operated saw, generally designated 10, which includes a base 20 having a horizontally disposed work surface 22. Work surface 22 is engageable with and supports a workpiece 2. Work surface 22 may include an indexing table 26 rotatably mounted within the base 20. A support member 30 is attached to the base 20 and is extends upwardly therefrom.

There is a saw blade assembly, generally designated 50, which has a motor 52 and a circular blade 54 rotatably driven by the motor 52. A saw blade cover 56 is provided for covering the upper half of the saw blade 54 and a blade guard 58 is provided for releaseably covering the lower half of the saw blade 54. The handle 60 is provided to assist the user in operating saw 10. By way of example in the drawing figures, the handle 60 is shown as being attached to the motor 52. However, other types of the handle 60 may be applied in the present invention.

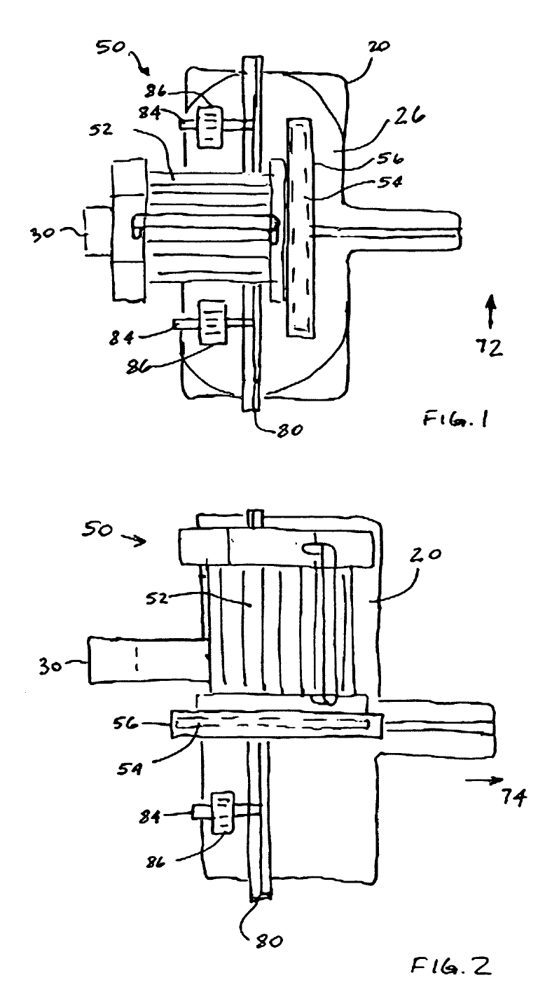

There is a means, generally designated 70, which is engageable with the support member 30 and the blade assembly 50 for rotating the blade assembly 50 in a horizontal plane and for selectively positioning the saw blade 54 within a cutting range. Such cutting range is characterized by a first cutting direction 72, best shown in FIG. 1, and at least a second cutting direction 74, best shown in FIG. 2.

Second cutting direction 74 is substantially perpendicular to first cutting direction 72 and, accordingly, saw blade 54 is rotated 90 degrees in a counter-clockwise direction in FIG. 2. The saw blade 54 positioned in the first cutting direction 72 has a surface thereof oriented towards the support member 30 and saw blade 54 is positioned in the second cutting direction 74 and has an edge portion thereof oriented towards the support member 30. It will be appreciated that the saw blade 54 may be further rotated in the counter-clockwise direction past the second position 74 as is well known in the relevant art form.

The saw 10 may include an elongated fence 80 which is attached to one of the base 20 and the support member 30 and wherein the first cutting direction 72 is parallel to fence 80.

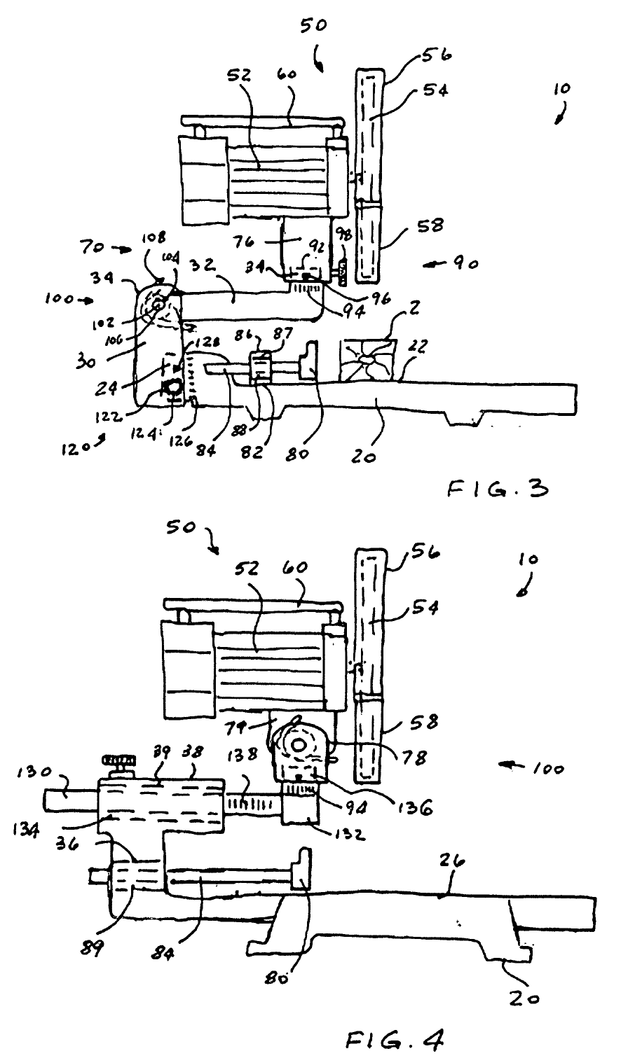

According to one embodiment of the invention, an adjusting means 82 is provided for adjustably attaching fence 80 to one of the base 20 and the support member 30. In the presently preferred embodiment of the invention, best shown in FIG. 3, such adjusting means 82 includes a pair of rails 84 each mounted for sliding movement within aperture 87 of the fence support member 86. Each fence support member 86 may be further provided with a bearing 88 disposed within an aperture 87 and the rail 84 is mounted for sliding movement within the bearing 88.

The blade positioning means 70 includes a mounting member 76 attached to blade assembly 50 and further includes a pivot means, generally designated 90, for pivotally connecting mounting member 76 to a free end of an elongated member 32 which is engageable with and extends outwardly from support member 30. Such pivotal arrangement enables the selective positioning of the saw blade 54 in the first cutting direction 72 and in the second cutting direction 74. The pivot means 90 includes a collar 34 formed in the free end of elongated member 32 and a cavity 92 formed in mounting member 76 of the blade assembly 50.

A pointer 96 is movable along the degree scale 94 during pivoting of the blade assembly 50 for positioning the blade 54 at a preselected cutting direction within the cutting range. It will be appreciated that the degree scale means 94 may be engageable with the mounting member 76 and the pointer 96 may be formed in the free end of the elongate member 32.

A locking means 98, which is preferably a knob 98, is threadably engageable with mounting member 76 and is engageable with the elongated member 32 for releasably locking the saw blade 54 in a cutting direction which is preselected within the cutting range during a rotation of the blade assembly 50 in the horizontal plane.

In further reference to FIG. 3, the saw 10 further includes a second pivot means, generally designated 100, for pivotally attaching a distal end of the elongated member 32 to the support member 30, whereby the saw blade 54 is selectively pivotable in a downward direction towards the work surface 22 for cutting such workpiece 2 and pivotable in an upward direction for releasing such workpiece 2. Such second pivot means 100 may include a shaft 102 which is extended through the aperture 104 of the elongated member 32 and through a pair of apertures 106 in a bifurcated end 34 of the support member 30. A torsion spring 108 is provided for biasing the elongated member 32 in the upward direction.

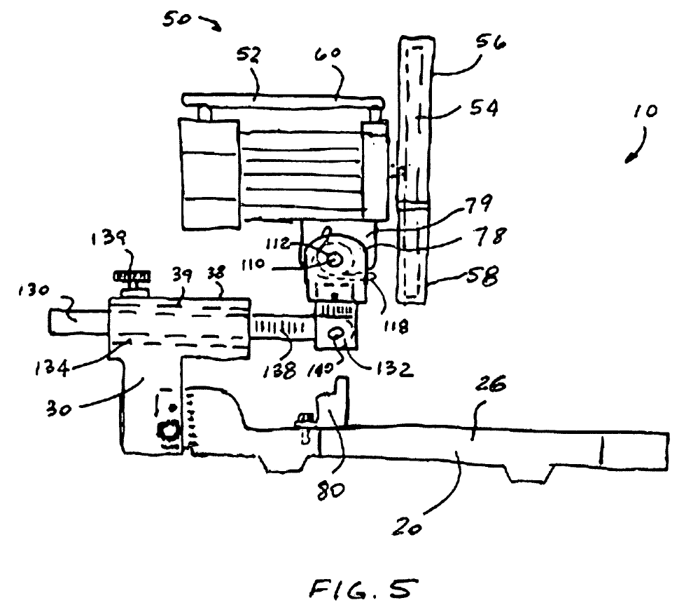

According to another embodiment of the invention, best shown in FIGS. 4-5, such second pivot means 100 includes the mounting member 76 having a bifurcated end 78 and further includes a member 79 which is attached to the blade assembly 50 and is pivotally connected to the bifurcated end 78 with a pivot shaft 110 extending through a pair of apertures 112 disposed in such bifurcated end 78. The blade assembly 50 is biased in the upward direction by a torsion spring 118.

Furthermore, the fence 80 may be slideably and adjustably mounted to the support member 30. Accordingly, the support member 30 is provided with an aperture 36 for slideably receiving the rail 84 and a bearing 89 may be further provided for aiding the sliding movement of the rail 84.

The saw 10 may further include a third pivot means, generally designated 120, for forming bevel cuts in the workpiece 2. According to one embodiment of the invention, such third pivot means 120 includes a collar 24 formed in the base member 20 and a cavity 122 formed in the support member 30. A locking member, such as a locking knob 124 is provided for locking the support member 30 at a preselected angle. A degree scale means 126 and a pointer 128 are provided for forming such preselected angle of the support member 30 and, more particularly, for positioning the saw blade 54 at such preselected angle.

Now in further reference to FIGS. 4-5, there is shown another embodiment of the present invention, wherein the support member 30 has a horizontally disposed elongated member 38 which is one of rigidly attached and integral to the support member 30. The blade positioning means 70 includes at least one rail 130 which is disposed parallel to the work surface 22 and is mounted for sliding movement within an aperture 39 provided within the elongated member 38. Support member 132 attached to one end of such at least one rail 130 includes a collar 136 for pivotal engagement with the bifurcated end 78 of the mounting member 76. At least one bearing 134 may be provided for aiding such sliding movement of the at least one rail 130.

A linear scale means 138 is provided for positioning such saw blade 54. A locking knob 139 is provided for securing the saw blade 54 in a preselected position. A pivot 140 is provided for pivoting saw blade 54 towards the work surface 22 when such saw blade 54 is positioned in the first cutting direction 72.

It will be apparent to those skilled in the art that the employment of at least one rail 130 is advantageous for forming rip cuts in the workpiece 2 when the saw blade 54 is positioned in the first cutting direction. The above arrangement is further advantageous in employing the fence 80, which is rigidly attached to the base 20.

In use, when the saw bale 54 is positioned in the first cutting direction 72, the saw 10 is employed for forming rip cuts and bevel cuts in a sheet type workpiece 2. When the saw blade 54 is positioned in the second cutting direction 74 or any other cutting direction within the cutting range, the saw 10 is employed as miter saw 10 of either a sliding or non-sliding type.

Although the present invention has been shown in terms of the well known locking knob for securing a position of the saw blade of the present invention, it will be apparent to those skilled in the art, that other locking means such as clamps, may be applied in the present invention.

Furthermore, the base 20 may be simply adapted for attachment to a support stand presently used for supporting the conventional sliding and non-sliding miter saws and which is further used for containing end stops engageable with the workpiece 2.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A power operated saw, said saw comprising:
(a) a base having a horizontally disposed work surface engageable with and supporting a workpiece;
(b) a support member connected to said base and extending upwardly therefrom;
(c) a saw blade assembly having a motor and a circular blade rotatably driven by said motor;
(d) means engageable with said support member and said blade assembly for rotating said blade assembly in a horizontal plane and for selectively positioning said blade within a cutting range, said cutting range characterized by a first cutting direction and at least a second cutting direction, said second cutting direction being substantially perpendicular to said first cutting direction, wherein said blade positioned in said first cutting direction has a surface thereof oriented towards said support member and wherein said saw blade positioned in said second cutting direction has an edge portion thereof oriented towards said support member.

2. The saw, according to claim 1, wherein said saw further includes an elongated fence attached to one of said base and said support member and said first cutting direction is parallel to said fence.

3. The saw, according to claim 2, wherein said saw further includes an adjusting means for adjustably attaching said fence to one of said base and said support member.

4. The saw, according to claim 3, wherein said adjusting means includes a pair of rails each mounted for a sliding movement within an aperture of a fence support member attached to said base.

5. The saw, according to claim 4, wherein said adjusting means further includes a bearing rigidly disposed within an aperture of each fence support member attached to said base and said each rail is mounted for a sliding movement within said bearing.

6. The saw, according to claim 3, wherein said adjusting means further includes at least one rail mounted for a sliding movement within an aperture formed in said support member.

7. The saw, according to claim 1, wherein said blade positioning means includes a mounting member attached to said blade assembly and a pivot means for pivotally connecting said mounting member to a free end of an elongated member engageable with and extending outwardly from said support member, whereby said pivotal connection enables said selective positioning of said blade in said first cutting direction and in at least said second cutting direction.

8. The saw, according to claim 7, wherein said pivot means includes a collar formed in one of said free end of said elongated member and said mounting member of said blade assembly and a cavity formed in an opposed one of said free end of said elongated member and said mounting member of said blade assembly.

9. The saw, according to claim 7, wherein said saw further includes a degree scale means engageable with one of said free end of said elongate member and said mounting member and a pointer formed in an opposed one of said free end of said elongate member and said mounting member, said pointer movable along said degree scale during pivoting of said blade assembly for positioning said blade in a cutting direction preselected within said cutting range.

10. The saw, according to claim 1, wherein said saw further includes a locking means disposed within said positioning means and engageable with a predetermined portion of said support member for releasably locking said blade in a cutting direction preselected within said cutting range during a rotation of said blade assembly in said horizontal plane.

11. The saw, according to claim 1, wherein said saw blade assembly includes an elongated member rigidly attached thereto at one end and a pivot means for pivotally attaching a distal end of said elongated member to said support member, whereby said blade is selectively pivotable in a downward direction towards said work surface for cutting such workpiece and pivotable in an upward direction for releasing such workpiece.

12. The saw, according to claim 1, wherein said blade positioning means includes a mounting member attached to said blade assembly, at least one rail which is disposed parallel to said work surface and mounted for a sliding reciprocal movement within said support member and a pivot means for pivotally connecting said mounting member to said at least one rail, and wherein said second cutting direction is substantially perpendicular to a direction of said sliding movement of said rail.

13. The saw, according to claim 12, wherein said saw further includes a linear scale means disposed on said at least one rail.

14. The saw, according to claim 12, wherein said saw further includes a locking means for securing said saw blade in order to form a rip cut of a predetermined width.

15. The saw, according to claim 1, wherein said saw further includes a pivot means for pivoting said blade at an angle to said horizontally disposed work surface for forming bevel cuts in such workpiece.

16. The saw, according to claim 1, wherein said pivot means includes a collar formed in one of said support member and said base and a cavity formed in an opposed one of said support member and said base.

17. The saw, according to claim 16, wherein said saw further includes a degree scale engageable with one of said support member and said base and a pointer formed on an opposed one of said support member and said base.

18. The saw, according to claim 1, wherein said saw further includes an indexing table rotateably mounted within said base and forming a portion of said work surface.

19. A power operated saw, said saw comprising:
(a) a base having a horizontally disposed work surface engageable with and supporting a workpiece;
(b) an indexing table rotateably mounted on said base for rotation thereto and forming a portion of said work surface;
(c) a support member rigidly attached to said indexing table and extending upwardly therefrom;
(d) a saw blade assembly having a motor and a circular blade rotateably driven by said motor;
(e) means engageable with said support member and said blade assembly for selectively positioning said blade in a first cutting direction and in a second cutting direction substantially perpendicular to said first cutting direction, wherein said blade positioned in said first cutting direction has a surface thereof oriented towards said support member and wherein said blade positioned in said second cutting direction has an edge portion thereof oriented towards said support member.
